(19) United States
(12) Patent Application Publication
(10) Pub. No.: US 2006/0044295 A1
(43) Pub. Date: Mar. 2, 2006

(54) Timing controller for flat panel display

(75) Inventors: Hui-Lung Yu, Sindian City (TW); Chia-Pu Ho, Jhonghe City (TW); Li-Ru Lyu, Jhubei City (TW)

Correspondence Address: THOMAS, KAYDEN, HORSTEMEYER & RISLEY, LLP, 100 GALLERIA PARKWAY, NW, STE 1750, ATLANTA, GA, 30339-5948, US

(73) Assignee: AU Optronics Corp.

(21) Appl. No.: 11/059,782

(22) Filed: Feb. 17, 2005

(30) Foreign Application Priority Data
Sep. 1, 2004 (TW) 93126326

(51) Int. Cl. G09G 5/00

(52) U.S. Cl. 345/204

(57) ABSTRACT

A timing controller (TCON) for use in flat panel displays to dynamically tune the display parameters thereof. The TCON comprises a bus master coupled to a bus and a register for configuring the register with a default value, and a bus slave coupled to an external interface for input of a custom value to configure the register, thereby rendering display parameters dynamically tunable.

### BACKGROUND

The invention relates to a timing controller for use in a flat panel display, capable of tuning display parameters dynamically.

Application Specific Integrated Circuit (ASIC) technology is widely applied in various system integrations. The major component controlling Liquid Crystal Display (LCD), a chip based on ASIC technology, is referred to as a timing controller (TCON).

FIG. 1a is an architecture diagram of a conventional liquid crystal display. The liquid crystal display comprises a display panel 116 for image display, and a timing controller 100 controlling the display panel 116. Digital input DATA_IN comprising image data and control signals is input externally to the timing controller 100, and through data transformation therein, visual output is displayed on display panel 116 via row driver 112 and column driver 114. While architecture varies between vendors, however, common display parameters are essential, comprising fast response time table, digital gamma table and temperature compensation table, configured to characterize relationships between the image data and visual output. Default parameters are predetermined at the manufacturing stage, and are stored in memory devices.

FIG. 1b shows a timing controller 100 comprising a register 102, a bus master 104, and a bus 108. The default parameters are stored in a memory 106 coupled to the bus 108. The bus 108 conforms to standards such as Inter-IC bus (12C) or Serial Peripheral Interface (SPI). The bus master 104 accesses memory 106 via bus 108 to read the default parameters therein, for storage in the register 102. Based on the parameters stored in register 102, the timing controller 100 transforms the image data into visual output for display on display panel 116 through control of row driver 112 and column driver 114.

FIG. 1c is a flowchart of a conventional display process. First in step S110, system power is switched on. In step S120, the bus master 104 reads default parameters from the memory 106 to initialize the timing controller 100. Thereafter, in step S130, the initialized timing controller 100 transforms the digital input DATA_IN into visual output for display on display panel 116 via control of row driver 112 and column driver 114.

A timing controller is so uniquely manufactured that it is not applicable in LCDs having varied specifications. In addition, since parameters are predetermined and set in the memory 106 at the manufacturing stage, it is difficult to tune the parameters when necessary. Digital input DATA_IN may be adjusted to fine tune the visual output, however, the quality of adjusted digital input DATA_IN is reduced during the transformation. Therefore it is desirable to omit the effect of parameters or render the parameters dynamically tunable.

### SUMMARY

An embodiment provides a timing controller for use in a flat panel display. The timing controller comprises a register, a bus, a bus master and a bus slave. Parameters required for display are stored in the register. Custom parameters are input externally via the bus. Default parameters are written to the flat panel display at power-on by a bus master. At least one custom parameter is received by the bus slave via the bus and written to the register for display.

The timing controller further comprises a memory coupled to the bus, storing the default parameters. The memory is an Electrically Erasable Programmable Read Only Memory (EEPROM) or a Flash ROM. The timing controller further comprises a switch coupled to the memory and the bus, and the switch is controlled by the bus slave. When a command is delivered from the external device to the bus slave, the bus slave activates the switch to provide the external device with access to the memory.

Another embodiment provides a flat panel display comprising a timing controller described, and a panel. The panel is coupled to the timing controller for display of the processed image data output therefrom.

A further embodiment provides an electronic device comprising a flat panel display described, and a power supply. The power supply is coupled to the flat panel display for supplying power needed by the electronic device.

### BRIEF DESCRIPTION OF THE DRAWINGS

The following detailed description, given by way of example and not intended to limit the invention solely to the embodiments described herein, will best be understood in conjunction with the accompanying drawings, in which:

FIG. 1a shows the architecture of a conventional flat panel display;

FIG. 1b shows the architecture of the internal interface of the conventional flat panel display;

FIG. 1c is a flowchart of a conventional control method;

FIG. 2a shows an embodiment of a flat panel display;

FIG. 2b shows an embodiment of the internal interface of the flat panel display in FIG. 2a;

FIG. 2c shows an embodiment of a control method; and

FIG. 3 shows an embodiment of an electronic device.

### DETAILED DESCRIPTION OF THE INVENTION

A detailed description of the present invention is provided in the following.

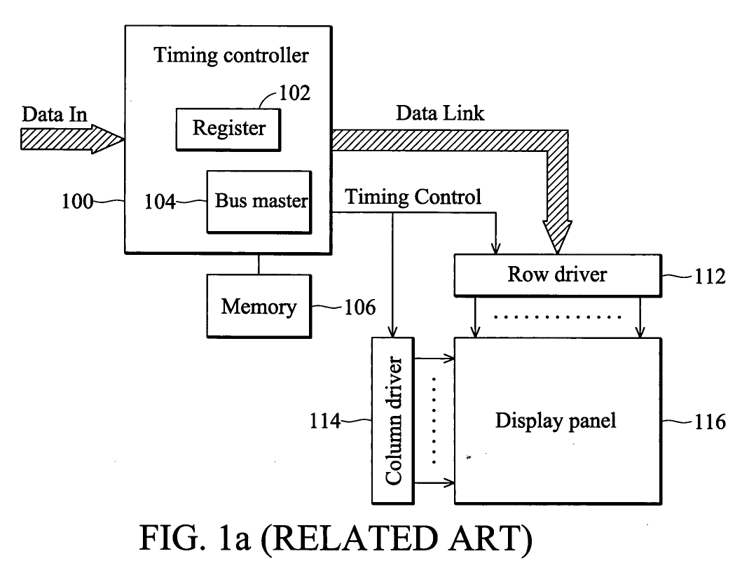

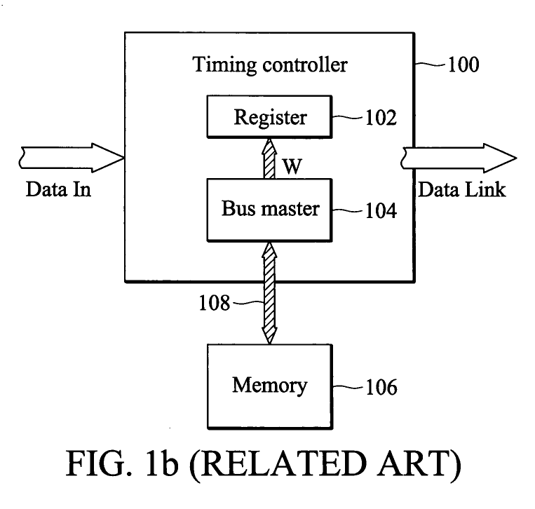

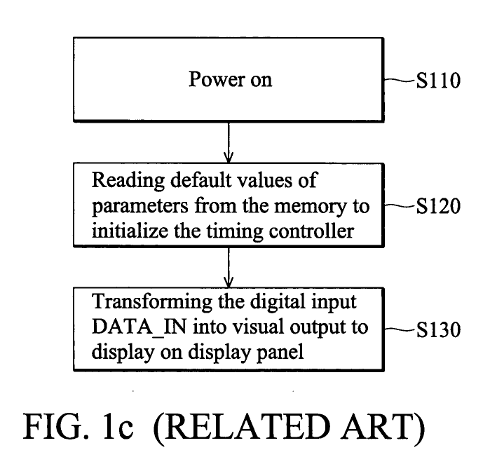

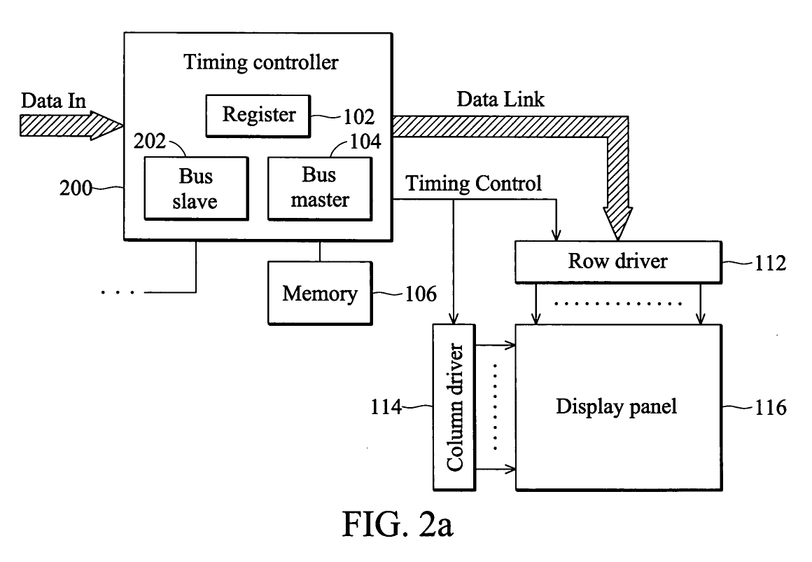

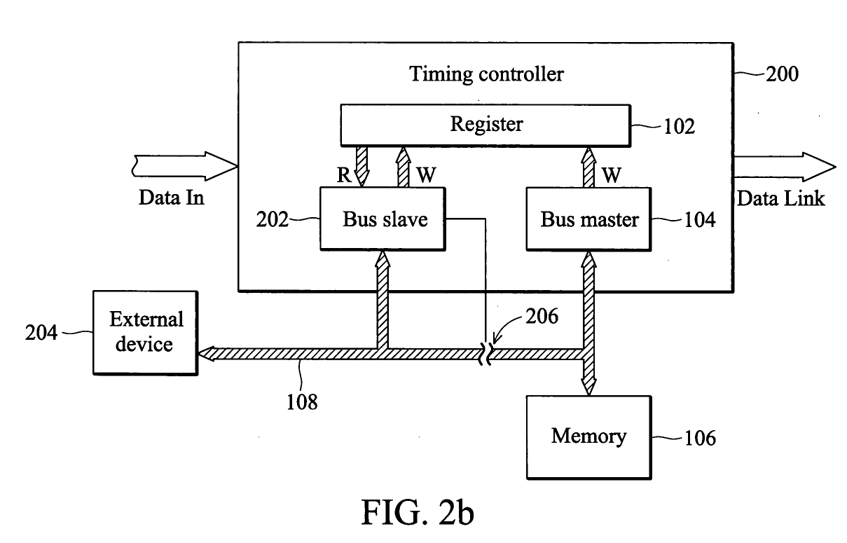

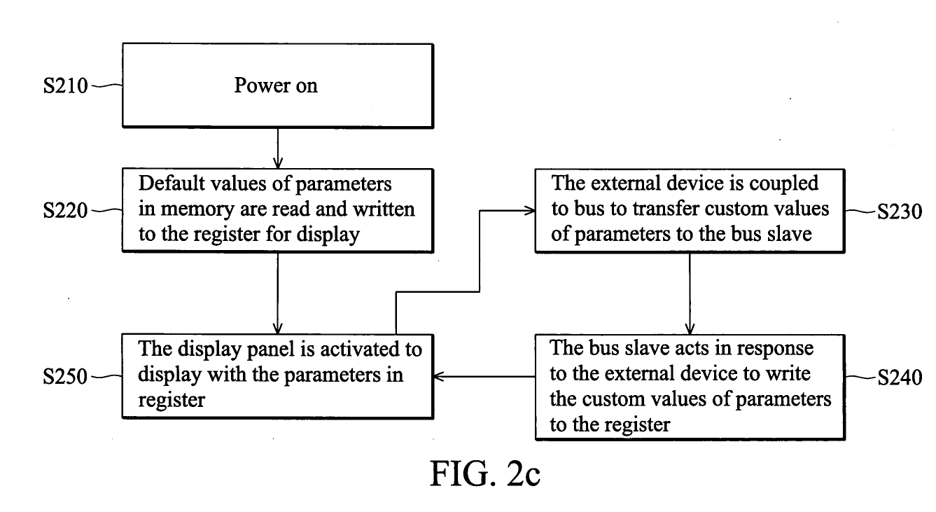

FIG. 2a shows an embodiment of the flat panel display comprising the bus master 104, the memory 106, the row driver 112, the column driver 114, and the display panel 116. Here a timing controller 200 replaces the timing controller 100 applied in the conventional display of FIG. 1a, comprising a bus slave 202 controlling external data transfer. The timing controller 200 receives digital input DATA_IN, transforms the input to visual output based on parameters, and displays the visual output on the display panel 116 via control of row driver 112 and column driver 114.

FIG. 2b is an embodiment of the internal interface of the flat panel display in FIG. 2a. The bus master 104 reads the default parameters in the memory 106 via the bus 108 after the flat panel display is powered on, and writes to the register 102. Thereafter, the bus master 104 can be disabled, being no longer necessary. The bus 108 connects the bus slave 202, and comprises an external interface for an external device 204. When the external device 204, comprising custom parameters, is connected, the custom parameters are transferred through the bus 108 and the bus slave 202, to the register 102 for display.

The bus 108 can comply with standards, such as system management bus (SMBUS), Inter-IC bus (12C) or Serial Peripheral Interface (SPI). The memory 106 can be EEPROM or FLASH. The parameters comprise a digital gamma table compensating and correcting brightness, a fast response table accelerating response time, and a temperature compensation table correcting environmental temperature effects. The external device 204 can be a PDA or a computer capable of transferring data via the bus 108.

The external device 204 can input custom parameters to the timing controller 200, and deliver specific control signals to the bus slave 202. For example, if gamma correction is undesired for previously corrected digital input DATA_IN, the external device 204 delivers a control signal to disable the digital gamma table in the timing controller 200. In some cases, the bus slave 202 comprises a switch 206 controlling the bus 108 between the memory 106 and external device 204. The default state of the switch 206 is off, thus only the bus master 104 can access the memory 106. When the external device 204 is connected to the bus 108 and delivers a specific control signal, the bus slave 202 switches the switch 206 on in response to the control signal, such that data in the memory 106 is accessible to the external device 204 for various applications.

FIG. 2c is a flowchart of the control process. In step S210, the system is powered on. In step S220, default parameters in the memory 106 are read and written to the register 102, for display, by the bus master 104. Once default parameters are completely read, the bus master 104 is disabled. Thereafter in step S250, the display panel 116 is activated under the control of timing controller 200, and displays based on the parameters in register 102. Unlike the conventional method, an external interface is provided in this embodiment, such that an external device can be connected to control the flat panel display. In step S230, the external device 204 is coupled to bus 108, and transfers custom parameters to the bus slave 202. In step S240, the bus slave 202 acts in response to the external device 204 to write the custom parameters to the register 102, overwriting the default parameters as configured in step S220. Afterwards, in step S250, the timing controller 200 transforms the digital input DATA_IN into visual output, and drives the display panel 116, via row driver 112 and column driver 114 to display. In addition, a switch 206 with default state off, is switched on in response to a control signal delivered from the external device 204 to the bus slave 202, such that the external device 204 is able to access data in the memory 106 for further application.

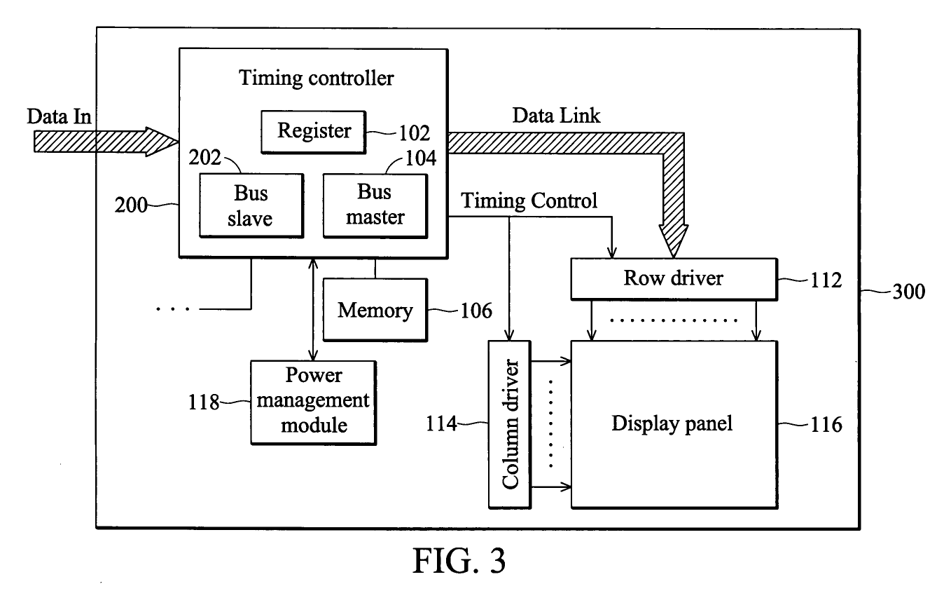

FIG. 3 is an embodiment of an electronic device 300 comprising the flat panel display described, and a power management module 118 providing DC voltage to the electronic device in response to control of the timing controller 200. The electronic device 300 can be a pocket PC or cell phone with corresponding components known in the art, therefore detailed descriptions are not provided herein.

While the invention has been described by way of example and in terms of preferred embodiment, it is to be understood that the invention is not limited thereto. Rather, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A timing controller for use in a flat panel display, comprising:
a register for storing a plurality of parameters required for display;
a bus for passing at least one of the plurality of parameters;
a bus master, coupled to the bus and the register, for writing at least one default parameter to the flat panel display; and
a bus slave, coupled to the bus and the register, for receiving at least one custom parameter passed via the bus, and writing the custom parameter to the register for displaying.

2. The timing controller as claimed in claim 1, further comprising a memory coupled to the bus for storing at least one default parameter.

3. The timing controller as claimed in claim 1, wherein the memory comprises an Electrically Erasable Programmable Read Only Memory (EEPROM) or a Flash ROM.

4. The timing controller as claimed in claim 2, further comprising a switch coupled to the memory and the bus and controlled by the bus slave.

5. The timing controller as claimed in claim 1, wherein the bus comprises a system management bus (SMBUS), an Inter-IC bus (12C) or a Serial Peripheral Interface (SPI).

6. The timing controller as claimed in claim 1, wherein each of the plurality of parameters comprises:
a digital gamma table for providing brightness correction and color temperature correction;
a fast response time table for tuning pixel response time; and
a temperature compensation table for compensating environment temperature effect on the flat panel display.

7. A flat panel display, comprising:
a timing controller for receiving and processing image data, comprising:
a register for storing a plurality of parameters required for display;
a bus for passing at least one of the plurality of parameters;
a bus master, coupled to the bus and the register, for writing at least one default parameter to the flat panel display; and
a bus slave, coupled to the bus and the register, for receiving at least one custom parameter via the bus, and writing the custom parameter to the register for displaying; and
a panel, coupled to the timing controller, for display of the processed image data.

8. The flat panel display as claimed in claim 7, further comprising a memory coupled to the bus for storing at least one default parameter.

9. The flat panel display as claimed in claim 8, further comprising a switch coupled to the memory and the bus and controlled by the bus slave.

10. The flat panel display as claim in claim 7, wherein the timing controller further generates a control signal according to the parameter, for tuning the display of the processed image data.

11. An electronic device, comprising:
a flat panel display comprising a timing controller and a panel, wherein the timing controller comprises:
a register for storing parameters required for display;
a bus for passing parameters;
a bus master, coupled to the bus and the register, for writing at least one default parameter to the flat panel display; and
a bus slave, coupled to the bus and the register, for receiving at least one custom parameter via the bus, and writing the custom parameter to the register for displaying; and
a power supply, coupled to the flat panel display, for supplying power to the electronic device.

12. The electronic device as claimed in claim 11, wherein the power supply receives a power management signal from the timing controller for adjusting output voltage and current.

13. The electronic device as claimed in claim 12, further comprising a memory, coupled to the bus, for storing the default parameter.

14. The electronic device as claimed in claim 13, further comprising a switch coupled to the memory and the bus and controlled by the bus slave.
